(19) United States
(12) Patent Application Publication
(10) Pub. No.: US 2025/0353015 A1
(43) Pub. Date: Nov. 20, 2025

(54) CHEMICAL DISPENSING DEVICE AND APPARATUS

(71) Applicant: GRM TEK, LLC, Ocala, FL (US)

(72) Inventors: Andrew Christopher Michaud, Bradenton, FL (US); Austin Christopher Reed, Ocala, FL (US)

(21) Appl. No.: 18/665,726

(22) Filed: May 16, 2024

(51) Int. Cl. B01L 3/00

(52) U.S. Cl. CPC B01L 3/523; B01L 3/527; B01L 2300/044; B01L 2300/049; B01L 2300/087

(57) ABSTRACT

A chemical dispensing device has an enclosure delimiting a first space and a second space. A first chemical is contained in the first space and a second chemical is contained in the second space. A one-way flow control device such as a p-trap or a check valve is located between the first space and the second space The one-way flow control device permits flow out of first space while preventing flow into the first space. When the device is activated, for example by breaking one or more frangible seals, the first chemical migrates from the first space into the second space, thereby combining or mixing with the second chemical to create a target chemical. The target chemical is dispensed from the enclosure through the port on the enclosure. The device is passive and functions without electronics or power.

### CROSS REFERENCE TO RELATED APPLICATIONS

N/A

### BRIEF DESCRIPTION OF THE DRAWINGS

FIG. 1 is a cutaway schematic of one embodiment of the invention configured with a p-trap.

FIG. 2 is a cutaway schematic another embodiment of the invention configured with a check valve.

FIG. 3 is cutaway schematic of the embodiment shown in FIG. 3 shown from the side.

FIG. 4 is another schematic of the embodiment shown in FIG. 3.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following description, for the purposes of explanation, numerous specific details are set forth in order to provide a thorough understanding of the present invention. It will be apparent, however, to one skilled in the art that the invention may be practiced without some of these specific details. Throughout this description, the embodiments and examples shown should be considered as exemplars, rather than as limitations on the invention. That is, the following description provides examples, and the accompanying drawings show various examples for the purposes of illustration. However, these examples should not be construed in a limiting sense as they are merely intended to provide examples of the invention rather than to provide an exhaustive list of all possible implementations of the invention.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

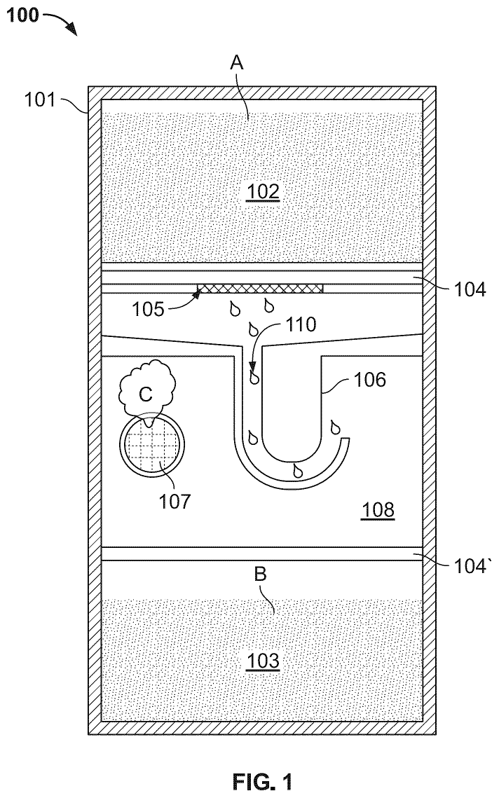

Referring to FIG. 1, shown is an embodiment of a dispensing device 100 comprising a tamper resistant enclosure 101. In some embodiments, the enclosure 101 is formed from materials which may prevent the leakage of the materials and chemicals contained within the enclosure 101, such materials including, for example, polyethylene terephthalate (PET, PETE), low density polyethylene (LDPE) or the linear low-density polyethylene (LLDPE). In some embodiments, the interior of the enclosure is divided into a first space 102, a second space 103, and a control space 108. In some embodiments, the control space 108 is disposed between the first space 102 and the second space 103, with a frangible seal 104 delimiting the respective spaces. For example, in some embodiments a frangible seal 104 separates the first space 102 from the control space 108 and another frangible seal 104′ separates the second space 103 from the control space 108. In some embodiments, the frangible seals can be substituted for a gate which, for example can be manually opened by a button on the exterior of the enclosure 101. In some embodiments, the frangible seals can be substitute by a vent pathway to the exterior of the enclosure 101.

Additionally, in some embodiments, a flow modulator 105 is disposed adjacent to at least one of the frangible seals 104 or 104′. In some embodiments, the flow modulator 105 is outer-facing relative to the frangible seal 104 (or 104′) such that it faces or extends forward the control space 108. The flow modulator 105 functions to modulate the flow rate of chemical A as further described below. For example, the flow modulator 105 may be an aperture, a valve, or a diffuser.

In some embodiments, a first material, chemical A, is stored in the first space 102 and a second material, chemical B, is stored in the second space 103. The device 100 is configured to mix chemical A and chemical B via a migration passage (where 110 points) that is defined by the components of the device in the control space 108. It an inactivated state, frangible seals 104 and 104′ prevent premature combination, reaction, or dispensing of chemical A and chemical B. Once the seals 104 and 104′ are broken, both chemical A and chemical B begin to migrate at least partially into the control space 108. However, a one-way flow control device, such as p-trap 106 is disposed between the first space 102 and the second space 103. In some embodiments, the p-trap 106 is provided adjacent to the first space 102 to control and promote flow of chemical A out of the first space 102 while preventing backflow into the first space 102. Accordingly, p-trap 106 enables flow in a single direction—of chemical A from the first space 102 into the control area 108 and/or the second space 103—while preventing flow of any material (chemical B, or the resultant target chemical C) back into the first space 102.

By following this migration passage (where 110 points), in some embodiments, chemical A reacts with chemical B in control area 108 or second space 103, or both, to generate a target chemical C. Accordingly, p-trap 106 provides a device to control the flow of chemical A and thereby control the rate of its reaction with chemical B and the resultant production of target chemical C. In some embodiments, the flow rate of chemical A is additionally modulated by the flow modulator 105, which in some embodiments is located upstream of the p-trap 106 on the migration passage 110. In some embodiments, with the flow modulator 105 employed, the flow modulator 105 controls the rate of flow (and thus rate of reaction) and the p-trap is employed to provide one-way flow and prevent backflow.

In some embodiments, the enclosure 101 includes a relief valve or port 107 to allow emission or dispensing of the target chemical C to the intended exterior environment, i.e. the environment external of the enclosure 101 of the device 100. In some embodiments, the port 107 is located adjacent to or about the control space 108 or adjacent to or about the second space 102.

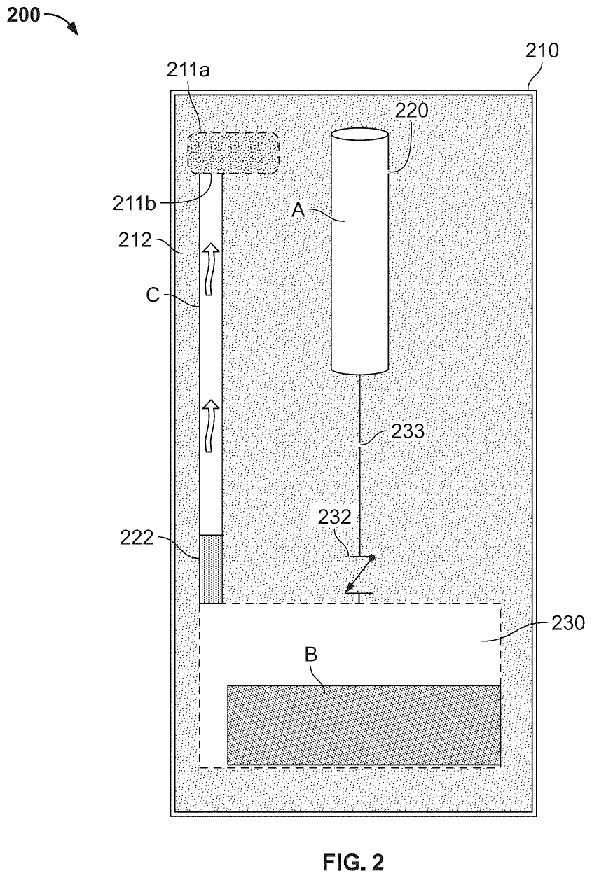

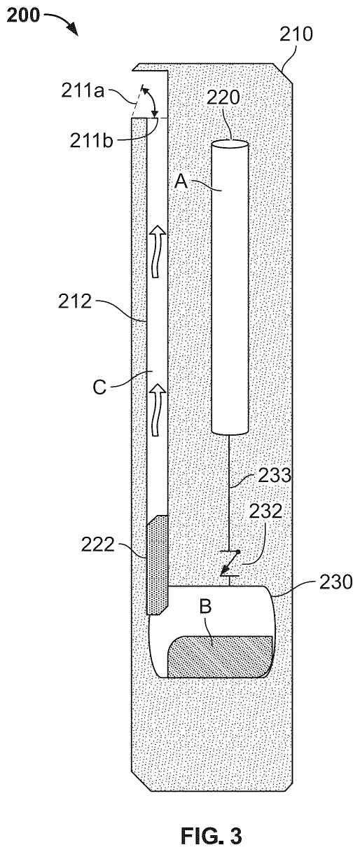

Referring to FIGS. 2-3, shown are other embodiments of a dispensing device 200 comprising a tamper resistant enclosure 210. In some embodiments, the interior of the enclosure 210 includes a first space 220 and a second space 230 wherein the first and second spaces are in flow communication by a migration passage 233. In some embodiments, disposed between the first space 220 and the second space 230 is a one-way flow control device 232 such as a check valve or membrane. For example, the one-way flow control device 232 may be disposed along the migration passage 233 which is disposed between and interconnects the first space 220 and the second space 230.

In some embodiments, a first material, chemical A, is stored in the first space 220 and a second material, chemical B, is stored in the second space 230. The device 200 is configured to mix chemical A and chemical B via the migration passage 233 upon activation of the flow control device 232. In an inactivated state, the flow control device 232 is closed to prevent premature combination, reaction, or dispensing of chemical A and chemical B. Once the flow control device 132 is opened, chemical A flows out of the first space 220, through the migration passage 233, and into the second space 230 where it mixed with chemical B. In some embodiments, the flow control device 232 is configured to enable flow in a single direction—of chemical A from the first space 220 into the second space 230—while preventing flow of any material (chemical B, or the resultant target chemical C) back into the first space 220. By following this migration passage 233, in some embodiments, chemical A reacts with chemical B in the second space 230 to generate a target chemical C. Accordingly, flow control device 232 provides a mechanism to control the flow of chemical A, and limit backflow, and thereby control the rate of its reaction with chemical B and the resultant production of target chemical C.

In some embodiments the flow control device 232 may comprise a one-way check valve, such as a ball check valve in which the closing member, the movable part to block the flow, is a ball. In some ball check valves, the ball is spring loaded to help keep it shut. In some embodiments, however, the ball-check valve does not require a spring, but rather is operative based on the presence or absence of backpressure, which moves the ball from a closed to an open position. In this configuration, the interior surface of the main seat of the ball check valve is conically-tapered to guide the ball into the seat and form a positive seal, stopping reverse flow. In other embodiments, other types of check valves other than ball valves may be employed, such as a check valve using a spring-loaded poppet. Other types of one-way flow control devices 232 may be employed, such as membranes or diaphragm valves.

In some embodiments, the enclosure 210 includes a relief valve or port 211a to allow emission or dispensing of the target chemical C to the intended exterior environment, i.e. the environment external of the enclosure 210 of the device 200. In some embodiments, the port 211a is in flow communication with the second space 230 through an exit passage 212. In some embodiments, port 211a is located at the distal end of the exit passage 212. In some embodiments, a frangible seal 211b is located adjacent, but downstream, from the port 211a. In some embodiments, the device 200 is activated by breaking the frangible seal 211b, which opens the enclosure 210 to atmosphere via the port 211a such that the higher relative pressure of the second space 230 is released, dropping below the relative pressure of the first space. In some embodiments, the frangible seal(s) can be substituted for a gate which, for example can be manually opened by a button on the exterior of the enclosure 101. In some embodiments, the frangible seals can be substitute by a vent pathway to the exterior of the enclosure 101, for example port 211a. As the pressure in the second space 230 drops below the relative pressure of the first space 220, the back pressure required to maintain a closed position for the one-way flow control device 232 is no longer maintained, causing the flow control device 232 to switch to the open position, causing chemical A to flow out of the first space 230, into the second space 230, and mix with chemical B to generate target chemical C, which exits through the exit passage 212 and out to the environment through port 211a.

In some embodiments, a flow modulator 222, is disposed along the exit passage 212, located upstream from the port 211a. In some embodiments, the flow modulator 222 is located at the proximal end of the exit passage 212, adjacent to the second space 230, and functions to control the rate of flow of the target chemical C out of the second space 230 and through the exit passage 212.

In some embodiments, the flow modulator 222 functions as both a physical barrier and an absorptive storage unit to contain the target chemical C to modulate and control the flow thereof out of the second space 230 and into the exit passage 212. Accordingly, in some embodiments, flow modulator 222 comprises a diffuser comprising a porous material such as silica gel which is configured to emit the absorbed chemical C into the exit passage 212 when the concentration of chemical C in the second space 230 is low. Conversely, when the concentration of chemical C in the second space 230 is high, the flow modulator 222 is configured to absorb chemical C until saturated.

For example, when chemical A and chemical B are mixed, the rate of production of chemical C increase rapidly. Accordingly, since the flow modulator 222 absorbs chemical C as the concentration of the chemical C in the second space 230 is increased, the amount of chemical C that is emitted from the flow modulator 222 may be smaller than the amount of chemical C emitted from the second space 230 during the initial mixing. Said differently, in some embodiments, there can exit a during which the discharge rate of chemical C that is generated in the second space 230 is greater than the discharge rate of chemical C from the flow modulator 222 into the exit passage 212.

When the amount of chemical C in the second space 230 reduces, the concentration of chemical C inside the flow modulator 222 is reduced, such that the flow modulator 222 may continue to emit the absorbed chemical C after the chemical C in the second space 230 is depleted. Consequently, the amount of chemical C that is emitted from the flow modulator 222 may be greater than the amount of chemical C emitted from the second space 230 at this time. As a result, the flow modulator 222 and the exit passage 212 both serve to reduce a change of the concentration amount of chemical C emitted from the second space 230. That is, when the discharge rate of chemical C that is emitted from the second space 230 is increased, the discharge rate of chemical C of the flow modulator 222 may be smaller than the discharge rate of chemical C of the second space 230. In contrast, when the discharge rate of chemical C emitted from the second space 230 is decreased, the discharge rate of chemical C of the flow modulator 222 into the exit passage 212 may be larger than the discharge rate of chemical C of the second space 230.

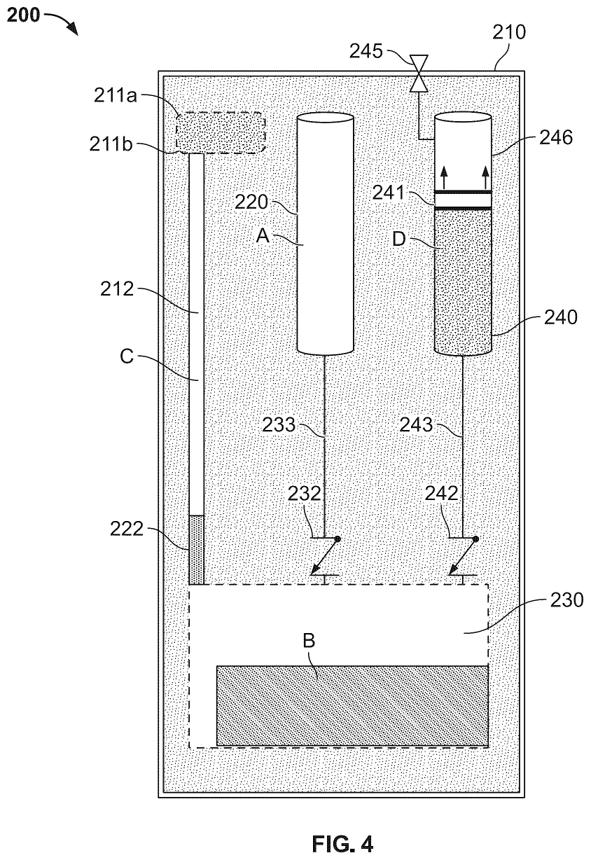

With reference to FIG. 4 shown is another embodiment of the dispensing device 200 similar to that show in FIG. 4 but with additional functionality. Here, a third space 240 is provided, which contains a third material, chemical D. The third space 240 is in flow communication with the second space 230 by a secondary migration passage 243. In some embodiments, the secondary migration passage 243 includes a one-way flow control device 242 such as a check valve or membrane. Additionally disposed in the third space 240 is a plunger 141 delimiting a vacuum pumped space 246 and a frangible seal 245 sealing the vacuum pumped space 246 from the exterior of the enclosure 210. In some embodiments, the second space 230, the exit passage 212, and port 211a are initially sealed by the frangible seal 211b. By increasing the pressure of the second space 230 above the relative pressure of the first space 220, third space 240, and the enclosure 210, adequate backpressure is created for one-way flow control devices 232 and 242 to remain in a closed position. When a user breaks the frangible seal 211b, opening the port 211a, the higher relative pressure of the second space 230 is released, dropping below the relative pressure of the first space 220 and third space 240. As the pressure in the second space 230 drops below the relative pressure of the first space 220, the back pressure required to maintain a closed position for the one-way flow control device 232 is no longer maintained, causing the flow control device 232 to switch to the open position, causing chemical A to flow out of the first space 230, into the second space 230, and mix with chemical B to generate target chemical C.

Additionally, in some embodiments, the vacuum pumped space 246 will maintain a lower pressure relative to the second space 230 and first space 220 until the seal 245 is broken. As a result, with the seal 245 closed, the one-way flow control device 242, which connects the third space 240 and second space 230, will maintain a closed position. When the seal 245 is broken, the flow control device 242 will change to the open position because the pressure in the vacuum pump space 246 rises and is equalized with the air pressure external to the enclosure 110, thereby creating enough hydrostatic pressure to cause the chemical D to flow down through the secondary migration passage 243, through the flow control device 242, and into the second space 230. This causes chemical D to mix with chemical A and chemical B in the second space 230. In some embodiments, chemical D and chemical A are the same, thereby creating a higher concentration of target chemical C upon mixing. In other embodiments, chemical D is different than chemical A (and/or chemical B), thereby increasing the flexibility of the device 200 to provide different combinations of mixtures and reactions.

It is appreciated and understood that the dispensing device 100 or 200 can be used in a wide variety of applications and with a wide variety of material and chemicals to combine and dispense target materials and chemicals into the surrounding environment. It is also noted that the present invention can be used to combine chemical (for example chemicals A and B) but not necessarily in a manner that cause a chemical reaction. Thus, the device 100 or 200 can be used for combining materials or chemicals and/or providing a means and mechanism for chemically reacting materials or chemicals. In the configurations disclosed, it is apparent that combining or reacting can be accomplished passively, that is without the need for electronics or power supplies, but rather through principals of pressure differentials and fluid mechanics.

It is further appreciated and understood that present invention is compatible with chemicals (such as chemical A, B, C, and D) of multiple and varied states of matter including solids, liquids, and gases. For example, liquids may include gels and other aqueous solutions and solids may include powders, concentrates, or aggregates. It is also understood that chemicals of different states can be combined (whether to cause a reaction or otherwise), for example chemical A can be a liquid and chemical B can be a solid, resulting in chemical C being a gas. In this sense, the state of the chemicals used is non-limiting in the context of this disclosure.

Applications include sanitation, food preservation, fumigation, odor control, pest control (pesticides or insecticides), growth control (herbicides), animal attractants or deterrents, pheromone imitation, bio-stimulants, and plant growth regulators or inhibitors.

For example, in a sanitization context, in some embodiments, chemical A comprises HCl, or another acidic feed material such as diluted or undiluted hydrochloric acid, citric acid, acetic acid, or lactic acid, and chemical B comprises sodium chlorite (NaClO₂). When sodium chlorite is decomposed into Na+ and ClO₂− by the mixture of chemical A and chemical B, the resultant target material, chemical C, is ClO₂ (chlorine dioxide), resulting from loss of the electron of ClO2−. Chlorine dioxide is a known and highly effective disinfectant. In some embodiments, chemical D can comprise additional water or acidic feed material to increase the reaction rate thereby creating a high level of chlorine dioxide as the target chemical C.

In another example, chemical A comprises water, such as distilled water, and chemical B comprises 1-Methylcyclopropene in solid form, the resultant target chemical C being gaseous 1-MCP which can function as a plant growth regulator or crop protector (insecticide, pesticide, or the like).

It is to be noticed that the term “comprising,” used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Put differently, the terms “including”, “comprising” and variations thereof mean “including but not limited to”, unless expressly specified otherwise.

Similarly, it is to be noticed that the term “coupled”, also used in the claims, should not be interpreted as being limitative to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The enumerated listing of items does not imply that any or all of the items are mutually exclusive, unless expressly specified otherwise. The terms “a” “an” and “the” mean “one or more”, unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

1. A chemical dispensing device, comprising:
an enclosure delimiting at least a first space and a second space, wherein a first chemical is contained in the first space and a second chemical is contained in the second space;
a one-way flow control device disposed between the first space and the second space, the one-way flow control device permitting flow out of first space and preventing backflow into the first space;
a port disposed on the enclosure;
wherein upon activation of the device, the first chemical migrates from the first space into the second space, thereby combining or mixing with the second chemical to create a target chemical; and
wherein the target chemical is dispensed from the enclosure through the port.

2. The chemical dispensing device of claim 1, wherein the one-way flow control device comprises a p-trap.

3. The chemical dispensing device of claim 1, wherein the one-way flow control device comprises a check valve.

4. The chemical dispensing device of claim 1, wherein the one-way flow control device comprises a membrane.

5. The chemical dispensing device of claim 1, including a flow modulator between disposed between the first space and the second space, wherein the flow modulator modulates flow of the first chemical from the first space.

6. The chemical dispensing device of claim 1, including a flow modulator disposed between the second space and the port, wherein the flow modulator modulates flow of the target chemical from the second space.

7. The chemical dispensing device of claim 1, wherein the device is passive and does not use electronics or power.

8. A chemical dispensing device, comprising:
an enclosure delimiting at least a first space, a second space, and a control space, wherein the control space is disposed between the first space and the second space;
a first chemical contained in the first space and a second chemical contained in the second space;
a one-way flow control device disposed in the control space, the one-way flow control device permitting flow out from the first space and preventing backflow into the first space;
a port disposed on the enclosure;
wherein upon activation of the device, the first chemical migrates from the first space into the second space through the one-way flow control device, thereby combining or mixing with the second chemical to create a target chemical; and
wherein the target chemical is dispensed from the enclosure through the port.

9. The chemical dispensing device of claim 8, wherein the first space and the control space are delimited by a first frangible seal and wherein the second space and the control space are delimited by a second frangible seal, wherein breaking the first and second frangible seals activates the device.

10. The chemical dispensing device of claim 8, wherein the one-way flow control device is a p-trap.

11. The chemical dispending device of claim 8, wherein the one-way flow control device is a check valve.

12. The chemical dispensing device of claim 8, including a flow modulator disposed between the first space and the control space, wherein the flow modulator modulates flow of the first chemical from the first space.

13. A chemical dispensing device, comprising:
an enclosure delimiting at least a first space and a second space; a first chemical contained in the first space and a second chemical contained in the second space;
wherein the first space and second space are connected by a migration passage;
a one-way flow control device disposed along the migration passage, the one-way flow control device permitting flow out from the first space and preventing backflow into the first space;
an exit passage connected to the second space, wherein the exist passage includes a port and a frangible seal;
wherein upon activation of the device, the first chemical migrates from the first space into the second space through the one-way flow control device, thereby combining or mixing with the second chemical in the second space to create a target chemical; and
wherein the target chemical is dispensed from through the port of the exit passage.

14. The chemical dispensing device of claim 13, wherein breaking the frangible seal activates the device.

15. The chemical dispensing device of claim 13, wherein the one-way flow control device is a check valve.

16. The chemical dispensing device of claim 13, including a flow modulator between disposed in the exit passage upstream from the port, wherein the flow modulator modulates flow of the target chemical from the second space.

17. The chemical dispensing device of claim 13, comprising:
a third space containing a third chemical, the third space connected to the second space by a secondary migration passage; and
a secondary one-way flow control device disposed along the secondary migration passage.

18. The chemical dispensing device of claim 17, wherein upon activation of the device, the third chemical migrates from the third space into the second space through the secondary one-way flow control device, thereby combining or mixing with the second chemical and/or the first chemical in the second space to create the target chemical.

19. The chemical dispensing device of claim 18, wherein the third space includes a plunger delimiting a vacuum pumped space within the third space and a secondary frangible seal sealing the vacuum pumped space, wherein breaking the secondary frangible seal in addition to the frangible seal activates the device.

20. The chemical dispending device of claim 17, wherein the secondary one-way flow control device is a check valve.
